(19) United States
(12) Patent Application Publication
(10) Pub. No.: US 2018/0040138 A1
(43) Pub. Date: Feb. 8, 2018

(54) CAMERA-BASED METHOD FOR MEASURING DISTANCE TO OBJECT (OPTIONS)

(71) Applicant: OBSHESTVO S OGRANICHENNOJ OTVETSTVENNOSTYU "DISIKON", Nizhnij Novgorod (RU)

(72) Inventors: Ivan Sergeevich SHISHALOV, Nizhnij Novgorod (RU); Andrei Viktorovich FILIMONOV, s. Kamenki (RU); Oleg Andreevich GROMAZIN, Nizhnij Novgorod (RU); Nikolay Vladimirovich POGORSKIY, Nizhnij Novgorod (RU)

(21) Appl. No.: 14/895,216

(22) PCT Filed: Aug. 26, 2015
(86) PCT No.: PCT/RU2015/000543

§ 371 Date: May 15, 2017

(30) Foreign Application Priority Data
Sep. 22, 2014 (RU) 2014137990

(51) Int. Cl. G06T 7/564; G06T 7/246

(52) U.S. Cl. CPC G06T 7/564; G06T 7/248

(57) ABSTRACT

This invention belongs to systems and methods for measuring distances to remote objects with a video camera.

According to the first option, the camera-based method for distance measurement involves the following steps: obtain at least one still frame and camera calibration parameters and then identify and enter dimensions of at least one object, the distance to which must be measured; then the distance to at least one selected object is measured on the basis of camera calibration parameters.

According to the second option, the camera-based method for distance measurement involves the following steps: obtain at least two time-lagged still frames and camera calibration parameters, select at least one object, the distance to which must be measured, form its model, and then determine the distance to the object based on the object model and camera orientation.

### TECHNICAL FIELD

This invention belongs to systems and methods for measuring distances to remote objects with a video sensor (camera).

### BACKGROUND

It is known that there are methods and systems for measuring distances to remote objects.

There is a well-known group of systems and methods that use so called lidars to determine a distance to an object. A lidar (abbreviation LIDAR stands for LIght Detection and Ranging) is a technology that helps receive and process data about remote objects with the help of active optical systems which use such phenomena as light reflection and dispersion in translucent and semi-translucent environments. These solutions have such drawbacks as the need to use auxiliary equipment, which makes the construction increase in cost and is not always feasible under conditions of video surveillance systems which have already been mounted.

In terms of technical level, such a method is known as measuring a distance to an object with an optical device (such as binoculars) or by visual estimation, “Sniper. Methodological Preparation” by A. F. Domnenko, Rostov-on-Don: Phoenix Publishing House, 2006-176 pages: illustrated. On the negative side, it is impossible to use this method within existing video surveillance and video monitoring systems.

There is an engineering solution patented under RU 2470376, “The Way of Determining Distance from Speedometer Camera to Vehicle (Options)”, by the applicant Recognition Technologies LLC, published on 20 Dec. 2012. The group of inventions belongs to equipment for control and measurement and may be used for determining a distance to a moving vehicle (V). A camera is placed in the way of the V. When the V appears in the controlled area, a still frame is made where its vehicle registration plate (VRP) is shown upon the V. Characters upon the VRP are recognized and used for identifying the VRP type. Coordinates of points (summits) of VRP image angles in the still frame coordinate system are measured and geometrical dimensions of the VRP image in the still frame are identified in pixels. In the group of inventions applied for, the distance is measured up to a certain V point, namely, up to the center of its VRP, regardless of how high the camera is mounted above the road. Apart from that, it is ensured that the height of VRP suspended above the road is determined. The use of this group of inventions enables its users to increase the possibility of identifying a V when speed limit violations are detected.

This engineering solution has such a drawback as the need to make an accurate reference of the camera to its location and the image made with it as well as take preliminary measurements of parameters stating mutual positions between the camera and its controlled area on the road surface: how high the camera is suspended above the road, the distance from the point where the camera projects onto the road to the point where the controlled area begins, etc., which is difficult to carry out when objects are extremely remote.

### SUMMARY

This invention is aimed at eliminating drawbacks typical of well-known engineering solutions. Technical result of this invention is to simplify construction of video monitoring systems and make it possible to use existing (mounted) systems for measuring distances to remote objects, without using any auxiliary equipment.

According to the first embodiment, the camera-based method for distance measurement comprises the following steps: obtaining at least one still frame and camera calibration parameters and then identifying and entering dimensions of at least one object, the distance to which must be measured; then the distance to at least one selected object is measured on the basis of camera calibration parameters.

In some embodiments, camera calibration parameters may include as follows:
focal length;
distortion ratios;
pixel size and pixel aspect ratio (PAR);
position of camera sensor in relation to optical axis;
data on image resolution.

In some embodiments, camera calibration parameters may include as follows:
vertical camera round-up;
aspect ratio;
resolution.

In some embodiments, calibration parameters shall be entered by the user.

In some embodiments, calibration parameters shall be received from the camera.

In some embodiments, calibration parameters shall be received from a special reference book based on information about the camera.

In some embodiments, calibration parameters shall be measured through special tests.

In some embodiments, several still frames shall be used in order to increase accuracy of distance measurement, with information being subsequently averaged out and analyzed in terms of statistics.

In some embodiments, the object shall be selected automatically, via video content analysis.

In some embodiments, the object shall be selected manually by the user.

In some embodiments, object dimensions shall be determined automatically according to the object database and their dimensions.

In some embodiments, object dimensions shall be set manually.

In some embodiments, object selection shall be set with user tools by selecting initial and final coordinate points along the X axis of the object, with object dimensions along this axis stated.

In some embodiments, object selection shall be is set with user tools by selecting initial and final coordinate points X and Y of the object, with object dimensions along the given axes stated.

In some embodiments, in order to increase accuracy, three object dimensions—along X, Y, and Z axes within the Cartesian coordinate system—shall be determined.

In some embodiments, object selection shall be set using a rectangle, with metric dimensions for the object set.

According to the second embodiment, the camera-based method for distance measurement comprises the following steps: obtaining at least two time-lagged still frames and camera calibration parameters, selecting at least one object, the distance to which must be measured, form its model, and then determining the distance to the object based on the object model and camera orientation.

In some embodiments, camera calibration parameters may include as follows:
focal length;
distortion ratios;
pixel size and pixel aspect ratio (PAR);
position of camera sensor in relation to optical axis;
data on image resolution.

In some embodiments, camera calibration parameters may include as follows:
vertical camera round-up;
aspect ratio;
resolution.

In some embodiments, calibration parameters shall be entered by the user.

In some embodiments, calibration parameters shall be received from the camera.

In some embodiments, calibration parameters shall be received from a special reference book based on information about the camera.

In some embodiments, calibration parameters shall be measured through special tests.

In some embodiments, the time lag shall be set beforehand (preset), at the setting stage.

In some embodiments, the time lag shall be determined dynamically, in response to pixel shifting of the object on the still frame.

In some embodiments, the object shall be selected automatically, via video content analysis.

In some embodiments, the object shall be selected manually by the user.

In some embodiments, for objects whose shape is not constant, video content analysis shall determine direction vectors showing motion of different object parts.

In some embodiments, the object model shall include meteorological data.

In some embodiments, the object model shall be selected from the pool of models and elaborated on the basis of data about object motion and/or ambient conditions.

In some embodiments, direction vectors showing motion of different object parts shall be compared to preset motion patterns subject to ambient conditions and elaborated on the basis of current data.

In one of the embodiments, the method as per the first option may be implemented as a system for measuring distances. Such a system shall include:

A photo- and/or video-recording device, at least one instruction processing unit, at least one data storage unit, at least one program where one or several programs are stored on at least one data storage unit and run on at least one instruction processing unit, with at least one program comprising instructions for implementing the method as per the first or the second option.

A camera configured to record videos and/or consecutive still frames or a video camera may be used as a photo- and/or video-recording device.

### BRIEF DESCRIPTION OF THE DRAWINGS

FIG. 1 is an example diagram of a distance measurement according the invention embodiment.

FIG. 2 is a diagram of a motion cloud with direction vectors estimation example.

### DETAILED DESCRIPTION

Terms used in the application shall be described below.

Camera means a photo-/video-camera or any other photo-/video-recording unit that is fitted with an optical system.

Focal length is a physical property of an optical system. In terms of a centered optical system that consists of spherical surfaces, it describes a capability to gather rays in one spot provided that these rays go from the infinity in a parallel beam being paralleled to the optical axis /1/.

Lens focal length is the distance from the optical center of the lens to the photo- or video-camera matrix /1/.

Distortion (from Latin distorsio, distortio) is an optical aberration typical of an optical system when linear magnification changes across the field of view, with similarity between the object and its image being distorted /1/.

Changes caused by lens distortion shall be determined as follows /2/:

Δxᵣ=x(k₁r²+k₂r⁴+k₃r⁶+ . . . ),

Δyᵣ=y(k₁r²+k₂r⁴+k₃r⁶+ . . . ),

where (Δxᵣ, Δyᵣ) mean image pixel deviation from its actual position, i.e. the position that the point would have with zero distortion, k_{1 . . . n} are distortion ratios which are constants for the set configuration of the camera optical system, and r=(x₂+y₂)^{1/2} is the distance from the frame center to the point with coordinates (x, y).

Camera resolution means the number of elements (pixels) in the camera matrix normally located along two axes.

Matrix size means a physical size of a camera matrix. It is normally measured in inches and set using the diagonal and aspect ratios.

Camera calibration is intended for obtaining internal and external camera parameters (so called calibration parameters) based on photos taken and videos recorded by it.

Angular diameter/dimension is the angle between the lines connecting diametrically opposite points of the object measured and the eye of the observer or the camera point.

This invention in its various embodiments may be completed as a method, including but not limited to a computer-implemented method in the form of a system or a machine-readable carrier comprising instructions for implementation of the method mentioned above.

In terms of this invention, a system means a computer system, an ECM (electronic computing machine), CNC (computer numerical control), a PLC (programmable logic controller), computer-aided control systems, and any other devices that can perform established and clearly defined series of operations (actions, instructions).

An instruction processing unit implies an electronic unit or an integrated circuit (microprocessor) that performs machine instructions (programs).

The instruction processing unit reads machine instructions (programs) from at least one data storage unit and performs them. Data storage units may include but are not limited to hard disk drives (HDD), flash drives, ROM (read-only memory), solid-state drives (SSD), and optical disk drives.

A program is a series of instructions meant to be performed by the computer controller or by the instruction processing unit.

According to the first preferable embodiment, the camera-based method for distance measurement involves the following steps:

Obtaining at Least One Still Frame and Camera Calibration Parameters

A still frame shall be understood as at least one video or photo shot (image) obtained from a photo- or video-camera. In some embodiments, several still frames are used in order to increase accuracy of distance measurement, with information being subsequently averaged out and analyzed in terms of statistics.

According to its manufacturer and required precision of results, camera calibration parameters may include but are not limited to:
focal length;
distortion ratios;
pixel size and pixel aspect ratio (PAR);
position of camera sensor in relation to optical axis;
data on image resolution.

In addition, calibration parameters may be expressed in the form of several abovementioned parameters combined.

In one of embodiments, camera calibration parameters may include vertical camera round-up (of 3 degrees, for instance), aspect ratio (4/3, for instance), and resolution (800×600, for instance). In this case the angle may be measured using a mere zoom-in (with the vertical camera round-up of 3 degrees and the number of pixels amounting to 800, we get 3/800=0.00375 degrees in one pixel both vertically and horizontally)

According to the type of embodiment, calibration parameters may be entered by a user, obtained from a camera or from a special reference book based on information about the camera, and measured through special tests.

Selecting and Entering Dimensions of at Least One Object, the Distance to which Must be Measured

The process of object selection (identifying its dimensions in pixels or pixel dimensions) may be performed automatically via video content analysis (a computer vision system) or manually by the user.

Object dimensions may be identified automatically according to the object database and their dimensions, with considerations given to object recognition performed by the video content analysis system /1/ or set manually by the user. Object dimensions shall be preset according to the metric system or any other system of measurements.

According to another embodiment, object selection shall be preset with a special user tool (such as a “ruler”) by selecting initial and final coordinate points along the X axis of the object, with object dimensions along the given axes stated.

A user tool is a graphical method of object selection when an input device is used to put (draw) a line connecting the initial and final coordinate points along one of the X or Y axes on top of the object.

According to another embodiment, object selection shall be preset with a user tool by selecting initial and final coordinate points X and Y of the object, with object dimensions along the given axes stated.

According to another embodiment, a relevant object shall be selected using a rectangle, with metric dimensions (width and height) for the object preset.

In some embodiments, in order to increase accuracy, three object dimensions—along X, Y, and Z axes within the Cartesian coordinate system—shall be determined.

Measuring the Distance to at Least One Selected Object on the Basis of Camera Calibration Parameters

Data about image resolution, camera angle of view, obtained pixel dimensions of the object shall be used to calculate the distance.

At the initial stage, object angular dimensions shall be obtained out of pixel dimensions preset by the user or established automatically.

Assume that there is an object set with two points having image coordinates (x₁ₚ, y₁ₚ) and (x₂ₚ, y₂ₚ), correspondingly. The following procedure shall be followed to normalize every point:

(xₙ,yₙ)=Normalize(xₙ,yₙ,cₓ,c_{y},f,s,k)

where cₓ and c_{y} are coordinates of the optical center of the lens in pixels, f is a focal length in pixels, s is pixel aspect ratio, k is a vector of distortion ratios.

Normalize Procedure /3/ shall transfer image coordinates into the coordinate system of the focal plane with distortions, camera sensor position, and pixel aspect ratio considered:

$${x}^{′} = ( {x}_{p} - {c}_{x} )$$

$${y}^{′} = ( {y}_{p} - {c}_{y} ) \cdot s \\ ( x , y ) = U ( \frac{{x}^{′}}{f} , \frac{{y}^{′}}{f} , k )$$

$$( {x}_{n} , {y}_{n} ) = ( x \cdot f , y \cdot f )$$

where U is a distortion compensation procedure that follows a point to find its location with zero distortion. As a result, we get (x₁ₙ, y₁ₙ) and (x₂ₙ, y₂ₙ), correspondingly.

Object angular dimensions shall be obtained by following the formula:

$$a = {cos}^{- 1} \frac{{x}_{1 n} {x}_{2 n} + {y}_{1 n} {y}_{2 n} + {f}^{2}}{\sqrt{{x}_{1 n}^{2} + {y}_{1 n}^{2} + {f}^{2}} \cdot \sqrt{{x}_{2 n}^{2} + {y}_{2 n}^{2} + {f}^{2}}}$$

As we can see, camera calibration parameters let us identify object angular dimensions for the preset dimension given in the image. With object angular and metric dimensions (the latter being obtained from the database), distance to the object may be measured. In some embodiments, distance to the object shall be measured as follows:

$$r = \frac{M}{2 * tg ( \frac{a}{2} )}$$

where r is the distance to the object to be found, M is the set metric dimension of the object, and a is the dimension established according to a calibration parameter (which links the angle of arrival of an image ray and an image pixel) and the angular dimension of the visible object selected on the section of the image in pixels.

According to the second preferable embodiment, the camera-based method for distance measurement involves the following steps:

Obtaining at Least Two Time-Lagged Still Frames and Camera Calibration Parameters

According to its manufacturer and required precision of results, camera calibration parameters may include but are not limited to:
focal length;
distortion ratios;
pixel size and pixel aspect ratio (PAR);
position of camera sensor in relation to optical axis;
data on image resolution.

In addition, calibration parameters may be expressed in the form of several abovementioned parameters combined.

According to another embodiment, camera calibration parameters may include vertical camera round-up (of 3 degrees, for instance), aspect ratio (4/3, for instance), and resolution (800×600, for instance). In this case the angle may be measured using a mere zoom-in (with the vertical camera round-up of 3 degrees and the number of pixels amounting to 800, we get 3/800=0.00375 degrees in one pixel both vertically and horizontally).

According to another embodiment, calibration parameters may be entered by a user, obtained from a camera or from a special reference book based on information about the camera, and measured through special tests.

Generally, a video flow is constantly being received from the camera, with the first still frame used to select an object, the distance to which needs to be measured, classify the object, and then choose a time lag according to the object type followed by selection of the second still frame, with the time lag considered, where the same object is selected.

In some embodiments, the time lag is determined automatically, in response to pixel shifting of the object on the still frame.

In some embodiments, the time lag is set beforehand (preset), while setting the system.

In some embodiments, there shall be obtained at least two still frames where the object is positioned differently.

Selecting at Least One Object, the Distance to which Needs to be Measured, and Create its Model

The object, the distance to which needs to be measured, shall be selected on still frames, and based on information about object changed position and/or dimensions as well as with the object type and weather conditions and other ambient conditions considered, we shall create an object model describing its behavior in time.

In some embodiments, an object model shall be understood as an object motion pattern. In the most elementary case, it shall be linear motion.

For instance, for an object such as a person, we can select a model describing the speed of their motion as the speed of 5 km/h.

The object may be selected automatically, via video content analysis (computer vision system) or manually by the user.

With manual selection, the user shall mark the object on at least two still frames recorded with a time lag.

Complicated objects that do not have constant shapes (such as smoke, gas clouds, etc.) consist of parts that may have different motion patterns (for example, some part of the smoke may go against the wind for some time due to various turbulences, etc.), which is also taken into consideration when creating a model.

If faced with complicated objects, the user shall use a manual mode (for example, when measuring a distance to the object “smoke”) to determine the direction in which the general front of the smoke has shifted due to the wind speed and wind direction in relation to the observer and mark it on several (at least 2) adjacent images.

In an automatic mode, video content analysis shall be used to identify a so called motion “cloud” within objects that do not have constant shapes, with a direction vector identified for different parts of the motion (hereinafter a “cloud” shall be understood as multiple object parts (points) that change their locations in time, with direction vectors identified for them, FIG. 2).

In different embodiments, the motion “cloud” found in still frames shall be compared to preset motion patterns subject to ambient conditions (such as a wind) and specified on the basis of current data.

Thus, if we take smoke for instance, the most likely model for current weather conditions can be chosen. Similarly, we can analyze a general situation for smoke when an automatic mode is used to find individual elements, then motion of each element between still frames is found, and as a result a motion “cloud” is created, with each element of this cloud having its own vector. A model (a pool of preset models may be set up) may be programmed with various motion “clouds” (for different object types—smoke, gas clouds, etc.) for different wind speeds and fire sizes (in the case of smoke), as the larger the fire is, the higher the speed against its vertical component shall be, and the stronger the wind is, the higher the speed against its horizontal component shall be.

In some embodiments, the object model includes meteorological data.

Measuring Distance to the Object Based on the Object Model and Camera Orientation

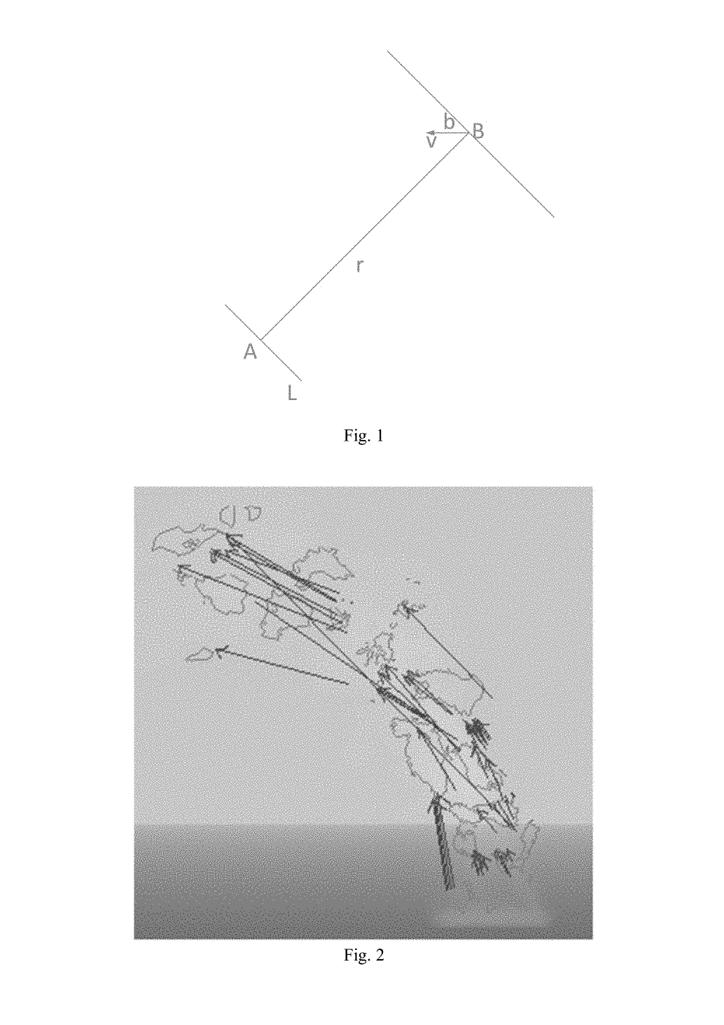

Assume that point A is camera position (FIG. 1) and B is the point where there is an object, the distance to which must be measured. Vector v characterizes actual (visible to the observer) motion direction of object B. Vector r is as long as the distance from the point of observation A to object B and directed from the point of object location to the point of observation (for quite remote objects and small angles of view, direction of this vector shall coincide with direction of the camera round-up). l is the plane where the matrix is positioned (i.e. the plane of projection where the image is formed).

Then, shift of object location in metric terms may be expressed with the following formula:

m=t*v*cos b,

where m is the required metric shift, t is the time lag between still frames taken (time in motion), v is the speed modulus of object motion measured, for instance in meters per second, and b is the angle between the motion vector and the plane of projection of the image.

Next, we need to obtain angular motion, shift from angular coordinate points.

Assume that the object in different still frames is located in points (x₁ₚ, y₁ₚ) and (x₂ₚ, y₂ₚ), correspondingly. The following procedure shall be followed to normalize every point:

(xₙ,yₙ)=Normalize(xₙ,yₙ,cₓ,c_{y},f,s,k)

where cₓ and c_{y} are coordinates of the optical center of the lens in pixels, f is a focal length in pixels, s is pixel aspect ratio, k is a vector of distortion ratios.

Normalize Procedure shall transfer image coordinates into the coordinate system of the focal plane with distortions, camera sensor position, and pixel aspect ratio considered:

$${x}^{′} = ( {x}_{p} - {c}_{x} )$$

$${y}^{′} = ( {y}_{p} - {c}_{y} ) \cdot s \\ ( x , y ) = U ( \frac{{x}^{′}}{f} , \frac{{y}^{′}}{f} , k )$$

$$( {x}_{n} , {y}_{n} ) = ( x \cdot f , y \cdot f )$$

where U is a distortion compensation procedure that follows a point to find its location with zero distortion. As a result, we get (x₁ₙ, y₁ₙ) and (x₂ₙ, y₂ₙ), correspondingly.

Object angular shift shall be obtained by following the formula:

$$a = {cos}^{- 1} \frac{{x}_{1 n} {x}_{2 n} + {y}_{1 n} {y}_{2 n} + {f}^{2}}{\sqrt{{x}_{1 n}^{2} + {y}_{1 n}^{2} + {f}^{2}} \cdot \sqrt{{x}_{2 n}^{2} + {y}_{2 n}^{2} + {f}^{2}}}$$

With object angular and metric shift results, distance to the object may be measured. In some embodiments, distance to the object shall be measured as follows:

$$r = \frac{M}{2 * tg ( \frac{a}{2} )}$$

where r is the required distance to the object, M is the estimated metric shift of the object on the plane where the lens matrix is positioned, and a is the dimension established according to a calibration parameter (which links the angle of arrival of an image ray and an image pixel) and the section of visible object motion marked on the image.

### Implementation Embodiments

According to the first preferable embodiment where video content analysis is used shall be described below.

Obtaining at Least One Still Frame and Camera Calibration Parameters;

Assume that the following camera calibration parameters are given:

Camera sensor position in relation to optical axis is set by the point where the optical axis is going through the matrix (sensor): cₓ=960 px, c_{y}=540 px

Focal length: f=26575 px (set in pixels)

Pixel aspect ratio s=1.05, (vertical against horizontal)

Distortion ratio k₁=−0.122, with ratios at higher degrees considered to be equal to zero.

Selecting and Entering Dimensions of at Least One Object, the Distance to which Must be Measured;

Video content analysis is used to detect emergence of the object, the distance to which must be measured. Assume that the camera has recorded such an object as a vehicle. As a result of video content analysis, the object on the still frame is recognized as a vehicle. Next, the object data base shall be searched for objects of the stated size. It shall be identified that the vehicle in the image is 4 m long, on average, with direction of vehicle observation being perpendicular to the vehicle (the length is shown without projection distortions)

Measuring the Distance to at Least One Selected Object on the Basis of Camera Calibration Parameters

Object angular dimensions shall be identified.

Assume that 2 points in the image have been marked: x₁=100, y₁=700, x₂=100, y₂=705.

After Normalize Procedure:

xₙ1=−860.11; yₙ₁=168.02; xₙ₂=−860.11, yₙ₂=173.27

Find object angular dimension a=0.01°

Having found object angular dimensions and using the data about its metric dimensions, we shall calculate the distance based on the following formula:

$$r = \frac{4}{2 * tg ( \frac{0.01 °}{2} )}$$

and get 22918 m, which is the distance to the object that had to be found.

Embodiment according to the second preferable embodiment shall be described below

Obtain at Least Two Still Frames with a Preset Time Lag and Camera Calibration Parameters

Assume that the following camera calibration parameters are given:

Camera sensor position in relation to optical axis is set by the point where the optical axis is going through the matrix (sensor): cx=960 px, cy=540 px.

Focal length: f=26575 px (set in pixels).

Pixel aspect ratio s=1.05, (vertical against horizontal).

Distortion ratio k₁=−0.122, with ratios at higher degrees considered to be equal to zero.

Time lag between still frames made is 0.1 seconds.

Selecting at Least One Object the Distance to which Needs to be Measured and Create its Model

A moving object shall be detected in 2 images and its location shall be marked in both images.

Assume that this object is moving at the speed of 4 m/s, with the angle between motion velocity vector and the plane of image projection of 45 degrees. Then, metric shift of any point (with a slight motion) shall be calculated as follows: m=0,1*4*cos 45°, and come to 0.28 meters.

Measuring Distance to the Object, Based on the Object Model and Camera Orientation

Assume that 2 points in the image have been marked: x₁=100, y₁=700, x₂=105, y₂=708

After Normalize Procedure:

xₙ₁=−860.11; yₙ₁=168.02; xₙ₂=−855.11, yₙ₂=176.42

Calculate angular motion relevant to the points in the image

Find the angle of object shift a=0.02°.

Having found the angle of object shift (0.02°) and having calculated its metric shift (0.28 meters), we shall calculate the distance to the object based on the following formula:

$$r = \frac{{0.23}_{M}}{2 * tg ( \frac{0.01 °}{2} )}$$

and get the distance of 658 meters.

### REFERENCES

1. Computer vision. A modern approach. David A. Forsyth, Jean Ponce, Williams Publishing House, 2004, 928 pages: illustrated.
2. Duane C. Brown “Decentering distortion of lenses”, 1966, Photogrammetric Engineering, volume 32, number 3, pages 444-462
3. OpenCV—Open Source Computer Vision online documentation http://docs.opencv.org/index.html

1: The camera-based method for distance measurement comprising the following steps:
obtaining at least one still frame and camera calibration parameters;
selecting and entering dimensions of at least one object, distance to which must be measured;
measuring the distance to at least one selected object on the basis of camera calibration parameters.

2: The method according to claim 1, wherein camera calibration parameters may include but are not limited to:
focal length;
distortion ratios;
pixel size and pixel aspect ratio (PAR);
position of camera sensor in relation to optical axis;
data on image resolution.

3: The method according to claim 1, wherein camera calibration parameters may include but are not limited to:
vertical camera round-up;
aspect ratio;
resolution.

4. (canceled)

5. (canceled)

6. (canceled)

7. (canceled)

8: The method according to claim 1, wherein several still frames shall be used in order to increase accuracy of distance measurement, with information being subsequently averaged out and analyzed in terms of statistics.

9: The method according to claim 1, wherein the object shall be selected automatically, via video content analysis.

10. (canceled)

11: The method according to claim 1, wherein object dimensions shall be determined automatically according to the object database and their dimensions.

12: The method according to claim 1, wherein object dimensions shall be set manually.

13: The method according to claim 1, wherein object selection shall be set with user tools by selecting initial and final coordinate points along the X axis of the object, with object dimensions along this axis stated.

14: The method according to claim 1, wherein object selection shall be is set with user tools by selecting initial and final coordinate points X and Y of the object, with object dimensions along the given axes stated.

15: The method according to claim 1, wherein in order to increase accuracy, three object dimensions—along X, Y, and Z axes within the Cartesian coordinate system—shall be determined.

16. (canceled)

17: The camera-based method for distance measurement comprising the following steps:
obtaining at least two time-lagged still frames and camera calibration parameters;
selecting at least one object, distance to which must be measured, and form its model;
determining the distance to the object based on the object model and camera orientation.

18: The method according to claim 17, wherein camera calibration parameters may include as follows:
focal length;
distortion ratios;
pixel size and pixel aspect ratio (PAR);
position of camera sensor in relation to optical axis;
data on image resolution.

19: The method according to claim 17, wherein camera calibration parameters may include as follows:
vertical camera round-up;
aspect ratio;
resolution.

20. (canceled)

21. (canceled)

22. (canceled)

23. (canceled)

24: The method according to claim 17, wherein the time lag shall be set beforehand (preset), at the setting stage.

25: The method according to claim 17, wherein the time lag shall be determined dynamically, in response to pixel shifting of the object on the still frame.

26: The method according to claim 17, wherein the object shall be selected automatically, via video content analysis.

27: The method according to claim 17, wherein the object shall be selected manually.

28: The method according to claim 17, wherein for objects whose shape is not constant, video content analysis shall determine direction vectors showing motion of different object parts.

29. (canceled)

30: The method according to claim 17, wherein the object model shall be selected from the pool of models and elaborated on the basis of data about object motion and/or ambient conditions.

31: The method according to claim 28, wherein direction vectors showing motion of different object parts shall be compared to preset motion patterns subject to ambient conditions and elaborated on the basis of current data.
